(19) United States
(12) Patent Application Publication
(10) Pub. No.: US 2008/0106527 A1
(43) Pub. Date: May 8, 2008

(54) Waveguide Configurations for Minimising Substrate Area

(75) Inventors: Benjamin Cornish, Brooklyn, NY (US); Robert Bruce Charters, Palmerston (AU); Warwick Todd Holloway, Kambah (AU); Ian Andrew Maxwell, New South Wales (AU); Dax Kukulj, Acton (AU)

Correspondence Address: MILLER, MATTHIAS & HULL, ONE NORTH FRANKLIN STREET, SUITE 2350, CHICAGO, IL, 60606, US

(73) Assignee: RPO Pty Limited, Acton (AU)

(21) Appl. No.: 11/935,124

(22) Filed: Nov. 5, 2007

(30) Foreign Application Priority Data
Nov. 6, 2006 (AU) AU 2006906162

(51) Int. Cl. G06F 3/042; G02B 6/32; G02B 6/10

(52) U.S. Cl. 345/176; 385/33; 385/131

(57) ABSTRACT

The invention describes various optical waveguide layouts with reduced substrate area, with particular application to reducing bezel width in optical touch systems. In certain preferred embodiments the optical waveguide layouts include a plurality of waveguide crossings.

### FIELD OF THE INVENTION

The invention relates to the design of an optical waveguide layout for minimising substrate area, and in particular for reducing bezel width in optical touch systems. However it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Touch input devices or sensors for computers and other consumer electronics devices such as mobile phones, personal digital assistants (PDAs) and hand-held games are highly desirable due to their extreme ease of use. In the past, a variety of approaches have been used to provide touch input devices. The most common approach uses a flexible resistive overlays although the overlay is easily damaged, can cause glare problems, and tends to dim an underlying screen, requiring excess power usage to compensate for such dimming. Resistive devices can also be sensitive to humidity, and the cost of the resistive overlay scales quadratically with perimeter. Another approach is capacitive touch, which also requires an overlay. In this case the overlay is generally more durable, but the glare and dimming problems remain.

In yet another common approach, a matrix of infrared light beams is established in front of a display, with a touch detected by the interruption of one or more of the beams. Such ‘optical’ touch input devices have long been known (U.S. Pat. No. 3,478,220; U.S. Pat. No. 3,673,327), with the beams generated by arrays of optical sources such as light emitting diodes (LEDs) and detected by corresponding arrays of detectors (such as phototransistors). They have the advantage of being overlay-free and can function in a variety of ambient light conditions (U.S. Pat. No. 4,988,983), but have a significant cost problem in that they require a large number of source and detector components, as well as supporting electronics. Since the spatial resolution of such systems depends on the number of sources and detectors, this component cost increases with display size and resolution.

An alternative optical touch input technology, based on integrated optical waveguides, is disclosed in U.S. Pat. No. 6,351,260, U.S. Pat. No. 6,181,842 and U.S. Pat. No. 5,914,709, and in US Patent Publication Nos. 2002/0088930 and 2004/0201579. The basic principle of such a device is shown in FIG. 1. In this optical touch input device, integrated optical waveguides (‘transmit’ waveguides) 10 conduct light from a single optical source 11 to integrated in-plane lenses 16 that collimate the light in the plane of a display and/or input area 13 and launch an array of light beams 12 across that display and/or input area 13. The light is collected by a second set of integrated in-plane lenses 17 and integrated optical waveguides (‘receive’ waveguides) 14 at the other side of the display and/or input area, and conducted to a position-sensitive (i.e. multi-element) detector 15. A touch event (e.g. by a finger or stylus) cuts one or more of the beams of light and is detected as a shadow, with position determined from the particular beam(s) blocked by the touching object. That is, the position of any physical blockage can be identified in each dimension, enabling user feedback to be entered into the device. Preferably, the device also includes external vertical collimating lenses (VCLs) 100 adjacent to the integrated in-plane lenses 16 and 17 on both sides of the input area 13, to collimate the light beams 12 in the direction perpendicular to the plane of the input area.

As shown in FIG. 1, the touch input devices are usually two-dimensional and rectangular, with two arrays (X, Y) of ‘transmit’ waveguides 10 along two adjacent sides of the input area, and two corresponding arrays of ‘receive’ waveguides 14 along the other two sides. As part of the transmit side, in one embodiment light from a single optical source 11 (such as an LED or a vertical cavity surface emitting laser (VCSEL)) is distributed to a plurality of transmit waveguides 10 forming the X and Y transmit arrays via some form of optical splitter 18, for example a 1×N tree splitter. The X and Y transmit waveguides are usually fabricated on an L-shaped substrate 19, and likewise for the X and Y receive waveguides, so that a single source and a single position-sensitive detector can be used to cover both X and Y dimensions. However in alternative embodiments, a separate source and/or detector may be used for each of the X and Y dimensions. For simplicity, FIG. 1 only shows four waveguides per side of the input area 13; in actual touch input devices there will generally be sufficient waveguides for substantial coverage of the input area.

Additionally, the waveguides may be protected from the environment by a bezel structure that is transparent at the wavelength of light used (at least in those portions through which the light beams 12 pass), and may incorporate additional lens features such as the abovementioned VCLs 100. Usually the sensing light is in the near IR, for example around 850 nm, in which case the bezel is preferably opaque to visible light. Typically, the input area 13 will coincide with a display, in which case the touch input device may be referred to as a ‘touch screen’ Other touch input devices, sometimes referred to as ‘touch panels’, do not have a display. The present invention applies to both types of input device.

Whilst this type of optical touch system performs well and is cost-effective compared to other touch systems, it suffers from a problem of bezel width. More specifically, the system as described in the aforementioned patents and patent applications has waveguide arrays that are essentially co-planar with the input area, and occupy space around the edge of the input area. The width of the waveguide area is determined by the number of waveguides 10 and 14, the separation between them, the size of the waveguides themselves, and the length of the associated in-plane lenses 16 and 17. However it is preferable to minimise the bezel width, i.e. the width of the waveguide arrays around the edge of the input area. By way of example, the intent in design of handheld devices such as mobile phones is to have relatively large displays with minimal area around the display, particularly on the lateral sides. The intent of many designers is to make the mobile phone display as wide as the device itself, with almost no excess device width. The advantage of this is that the user gets the largest possible display for the device size, which is both more practical and aesthetically pleasing. For this reason, waveguide layouts that reduce the array width while retaining an appropriate number of waveguides (for spatial resolution) are desirable.

More generally, it is frequently desirable to reduce the area occupied by a layout of integrated optical waveguides, for example to occupy less space within a larger assembly or to reduce the costs associated with substrate or waveguide materials.

It is an object of the present invention to overcome or ameliorate at least one of the disadvantages of the prior art, or to provide a useful alternative.

### DISCLOSURE OF THE INVENTION

In a first aspect the present invention provides a waveguide assembly for passing signals to or from an input area of an optical touch input device, said assembly comprising a plurality of waveguides extending between a respective plurality of lenses and a respective signal detector of signal source, wherein at least one waveguide crosses over at least one other waveguide in said assembly.

According to a second aspect the present invention provides a waveguide assembly for passing signals to or from an input area of an optical touch input device, said assembly comprising a waveguide fairway defined by a plurality of waveguides that, at least along part of their length, extend in an array to thereby define inner and outer sides of said fairway, wherein waveguides on said outer side of said fairway cross over other waveguides in said array to said inner side of said fairway for connection to lenses facing said input area of said touch input device.

According to a third aspect the present invention provides waveguide assembly for passing signals to or from an input area of an optical touch input device, said assembly comprising a waveguide fairway defined by a plurality of waveguides that, at least along part of their length, extend in an array to thereby define inner and outer sides of said fairway, wherein each said waveguide at some point along its length is directed toward said outer side of said fairway.

Preferably the plurality of waveguides extend along at least part of their length in a mutually parallel spaced apart array.

Preferably the waveguides cross each other at an angle sufficiently large to minimise signal interference or cross talk between the waveguides. Preferably the size of the angle is a function of i) the materials comprising the waveguides; and/or ii) the wavelength of an optical signal transmitted by the waveguides. Preferably the angle is greater than 10 degrees. Preferably the angle has a value in the interval 10 to 40 degrees, such as, 11, 12, 13, 14, 15, 16, 17, 18, 19, 20, 21, 22, 23, 24, 25, 26, 27, 28, 29, 30, 31, 32, 33, 34, 35, 36, 37, 38 or 39 degrees.

According to a fourth aspect the present invention provides a method for reducing bezel width in an optical touch input device; said method comprising the steps of providing a waveguide assembly for passing signals to or from an input area of said optical touch input device, said assembly comprising a plurality of waveguides extending between a respective plurality of lenses and a respective signal detector or signal source, wherein at least one waveguide crosses over at least one other waveguide in said assembly.

According to a fifth aspect the present invention provides a method for a educing bezel width in an optical touch input device; said method comprising the steps of providing a waveguide assembly for passing signals to or from an input area of said optical touch input device, said assembly comprising a waveguide fairway defined by a plurality of waveguides that, at least along part of their length, extend in an array to thereby define inner and outer sides of said fairway, wherein waveguides on said outer side of said fairway cross over other waveguides in said array to said inner side of said fairway for connection to lenses facing said input area of said touch input device.

According to a sixth aspect the present invention provides a method for reducing bezel width in an optical touch input device; said method comprising the steps of providing a waveguide assembly for passing signals to or from an input area of said optical touch input device, said assembly comprising a waveguide fairway defined by a plurality of waveguides that, at least along part of their length, extend in an array to thereby define inner and outer sides of said fairway, wherein each said waveguide at some point along its length is directed toward said outer side of said fairway.

In a related aspect the present invention provides a waveguide assembly for an optical touch input device comprising a first waveguide allay adapted to pass a signal between a signal detector/source and a plurality of lenses positioned along a first side of an input area of the device,

and a second waveguide array adapted to pass a signal between a signal detector/source and a plurality of lenses positioned along a second side of the input area,

wherein at least along part of their length the first and second waveguide allays are stacked on each other.

In a related aspect the present invention provides a waveguide assembly for an optical touch input device comprising a waveguide array adapted to pass a signal between a signal detector/source and a plurality of lenses positioned along one or more sides of an input area of the device, wherein the waveguides in the array are stacked in two or more layers so as to reduce a dimension of the waveguide array in the plane of the input area.

In a related aspect the present invention provides a method for reducing bezel width in an optical touch input device comprising forming a waveguide assembly for passing signals to and from the device, according to any one or more of the previous aspects.

The term “crossing over” is to be construed as either the passing of one waveguide through another (in other words, the coplanar intersection of waveguides), or alternatively, a configuration whereby one waveguide forms a bridge over another waveguide. Both of these constructions are within the purview of the present invention. The above-mentioned aspects of the invention can be used separately or may be combined to reduce the width of the waveguide assembly surrounding the input area of an optical touch input device and thereby reduce bezel width.

Further advantages arising from the abovementioned aspects of the invention will be discussed below.

### BRIEF DESCRIPTION OF THE DRAWINGS

The present invention will now be described by way of example only with reference to the accompanying drawings in which:

FIG. 1 illustrates a plan view of a conventional waveguide-based optical touch input device;

FIG. 2 illustrates a prior art configuration for the transmit side of a waveguide-based optical touch input device;

FIGS. 3a and 3b illustrate a conventional transmit side in-plane lens and a transmit side in-plane lens as disclosed in US 2006/0088244 A1 respectively, which may be used with the present invention;

FIG. 3c illustrates the radiation loss associated with a reduced length receive side in-plane lens;

FIG. 4 illustrates a transmit side waveguide layout according to a first embodiment of the present invention;

FIG. 5 illustrates a transmit side waveguide layout according to a second embodiment of the present invention;

FIG. 6 shows a close-up of a waveguide crossing that occurs in a waveguide layout according to a second embodiment of the present invention;

FIG. 7 illustrates a transmit side waveguide layout according to the third embodiment of the present invention;

FIG. 8 illustrates a receive side waveguide layout according to the fourth embodiment of the present invention;

FIGS. 9a and 9b illustrate a transmit side waveguide layout according to a fifth embodiment of the present invention;

FIGS. 9c and 9d illustrate transmit side waveguide layouts according to a sixth embodiment of the present invention;

FIG. 10a illustrates transmit waveguide arrays required for ‘pen resolution’ and ‘finger resolution’ operation;

FIGS. 10b, 10c and 10d illustrate various receive waveguide arrays for ‘finger resolution’ operation; and

FIGS. 11a, 11b and 11c illustrate stacked waveguide arrays according to a seventh embodiment of the present invention.

### DESCRIPTION OF THE INVENTION

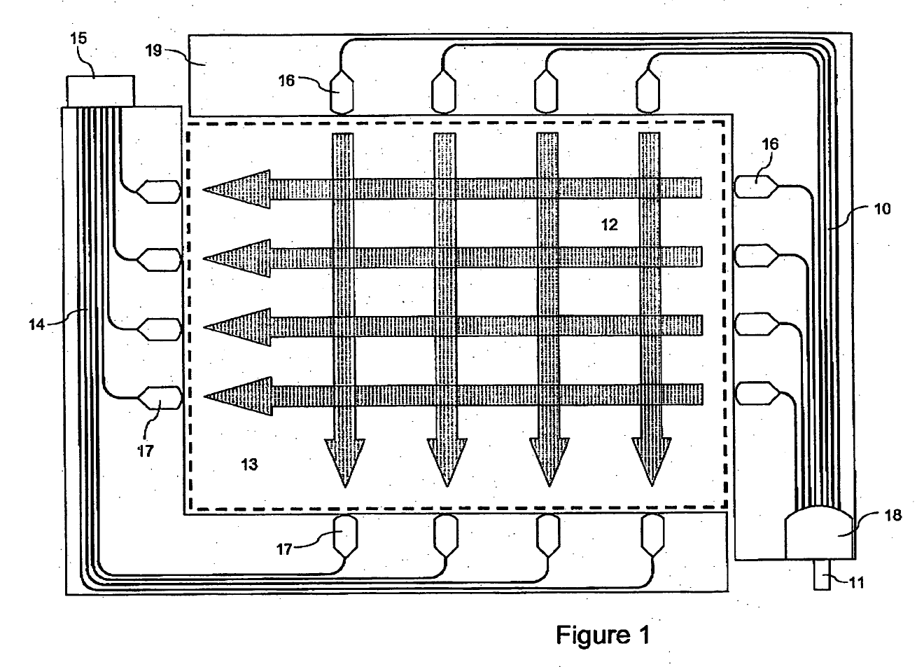

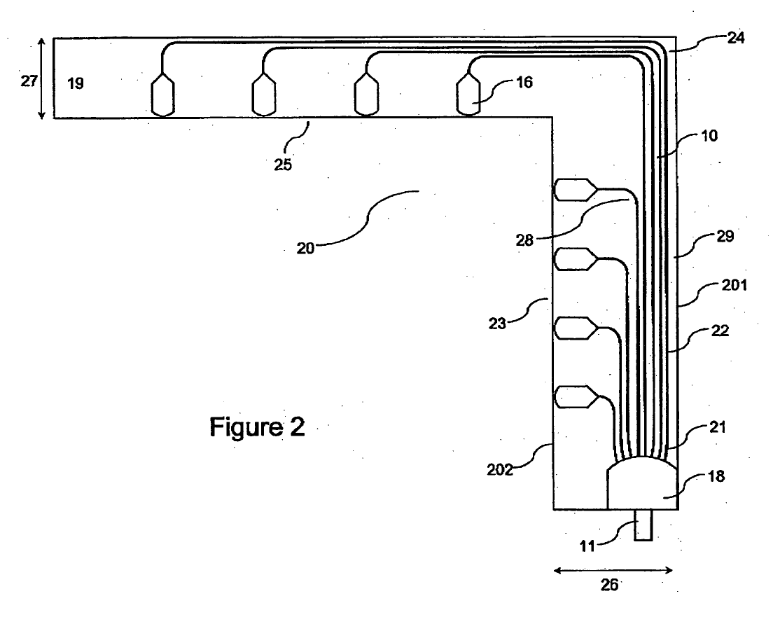

FIG. 2 shows details of a prior art transmit side waveguide portion 20 that forms part of the touch input device of FIG. 1. The waveguide portion 20 has an L-shaped substrate 19 bearing a 1×N tree splitter 18 and N waveguides 10 with associated in-plane lenses 16. A light source 11, in one embodiment a vertical cavity surface emitting laser (VCSEL), launches light into a 1×N tree splitter 18 that distributes the light more or less equally into the N waveguides. Details of some suitable 1×N tree splitters 18 are described in US Patent Publication No 2006/0188198 A1, incorporated by reference herein in its entirety. With such splitters, each waveguide 10 preferably points towards the light source 11, resulting in a ‘fan-out region’ 21 before the waveguides 10 run substantially straight and parallel to the edges 201 and 202 of the substrate 19. This fan-out feature is preferable fox light distribution efficiency but is not essential and may be omitted, in which case each output waveguide 10 exits the splitter running substantially straight and parallel to its neighbours. For simplicity, the fan-out region is not always shown in subsequent figures, and its presence or absence does not affect the principles of the invention. After the fan-out region 21, the waveguides 10 run substantially straight and parallel in a waveguide fairway 22 along a first leg 23 of the waveguide portion 20, before each waveguide in turn peels off through a bend 28 to its respective in-plane lens 16. The waveguide fairway 22 includes a cornet region 24, where the waveguides 10 turn to run alongside a second leg 25 of the waveguide portion. The prior art receive side waveguide configuration is similar, except that the fan-out region and splitter are omitted and the optical source is replaced by a multi-element detector.

The transmit and receive waveguide portions required for waveguide-based optical touch systems may be fabricated from a variety of materials, including glasses and polymers. As discussed in US Patent Publication No 2007/0190331 A1 and International PCT Application No PCT/AU2007/000571 for example (each of which is incorporated herein by reference in its entirety), a cost-effective method for fabricating these waveguide portions is photolithographic patterning of photo-curable polymers by UV exposure through a mask, followed by solvent development. However the principles of the present invention apply irrespective of the material system and fabrication methods chosen.

It will be appreciated that the splitter 18, waveguides 10 and in-plane lenses 16 all occupy considerable space on a substrate 19, so that the width 26 of the first leg 23 of the transmit waveguide portion 20 is not insubstantial. As will be seen in a detailed example below, the width 26 will be of order 1 cm, which contributes directly to bezel width in a touch input device. The width 27 of the second leg 25 will be smaller because there are fewer waveguides along that side, but the associated bezel width will still be relatively substantial.

Inspection of the waveguide layout in FIG. 2 shows that there are four main contributions to bezel width: the array of waveguides 10, the bends 28, the in-plane lenses 16, and the gap 29 between the outer edge 201 of the substrate 19 and the outermost waveguide in the fairway 22. In the particular configuration shown in FIG. 2, the bends 28 are tight angle bends, required when the waveguide fairway 22 runs parallel to one or more sides of a rectangular input area and the sensing beams are perpendicular to the sides (as shown in FIG. 1). However in certain optical touch sensor configurations this need not be the case; for example the bends would not be right angles if the sensing beams were angled obliquely to the display sides (as in U.S. Pat. No. 5,414,413) or if off-axis reflectors were used to collimate the sensing beams instead of in-plane lenses, as disclosed in US Patent Publication No 2006/0188196 (incorporated herein by reference in its entirety). The inventive principles apply irrespective of the precise angles through which the waveguides turn at the bends 28.

By way of specific example of the dimensions involved in this construction, one particular transmit side waveguide layout 20 with a total of N=116 waveguides 10 requires a ‘first side’ substrate width 26 of about 9.5 mm, comprising 4.8 mm for the length of the in-plane lenses 16, 0.8 mm for the gap 29, 1.5 mm for the bend 28, and 2.4 mm for the array of 116 waveguides 10. In this example the waveguides are 10 μm wide on a 20 μm pitch (i.e., separated by 10 μm gaps), which is relatively straightforward for a photopatterning/solvent development fabrication process for example. However attempting to significantly reduce these dimensions may cause problems such as misshapen waveguides and gap filling. It will be appreciated that there needs to be a small gap between the end of each in-plane lens 16 and the inner edge 202 of the substrate 19, to provide a margin for the dicing process used to cut the substrate, however this gap need only be approximately 30 to 50 μm and makes an insignificant contribution to bezel width. This waveguide layout would be suitable for fitting around a rectangular display with approximate dimensions 50 mm×66 mm, with 50 waveguides and in-plane lenses along the shorter side and 66 along the longer side. Each of the four main contributions to bezel width, and methods for reducing them, will now be addressed in turn.

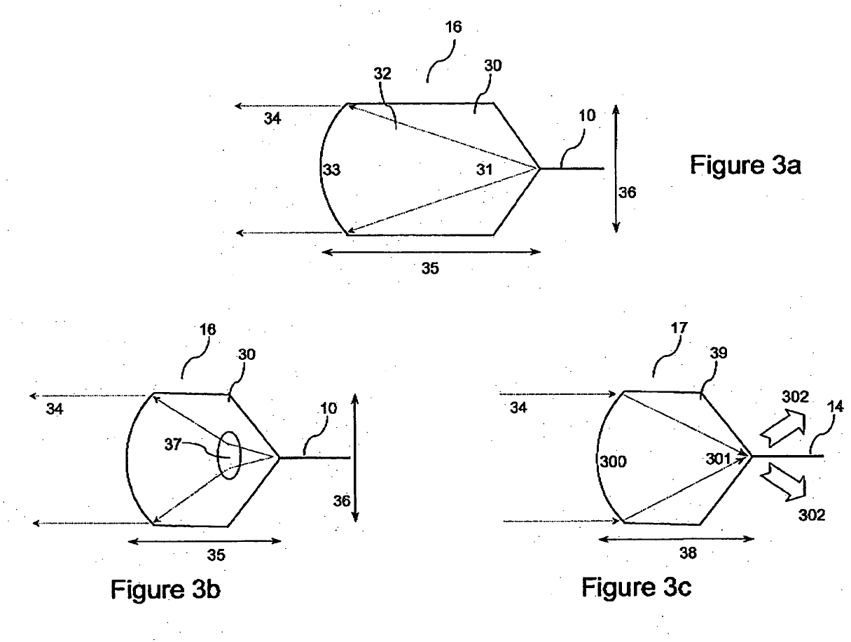

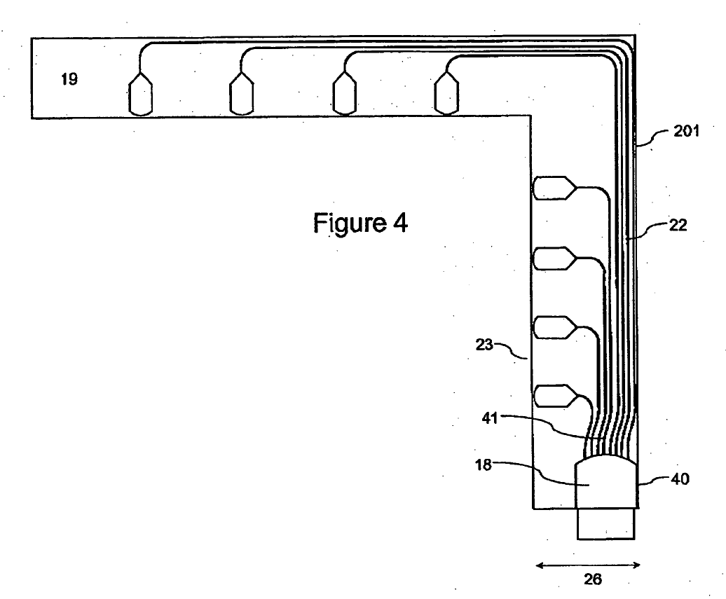

In the specific design described above, the largest single contribution to bezel width is clearly the in-plane lenses 16, whose length of 4.8 mm contributes approximately 50% of the total width. The design and purpose of these in-plane lenses are discussed in US Patent Publication No 2006/0088244 A1 (incorporated herein by reference in its entirety). As shown in FIG. 3a, a conventional transmit-side in-plane lens 16 comprises a slab region 30 within which light 32 from a transmit waveguide 10 diffracts in the horizontal plane with a divergence angle 31 before being collimated by the curved end face 33 to form a sensing beam 34. For this particular exemplary embodiment, the in-plane lens 16 has a length 35 of 4.8 mm, a width 36 of 0.95 mm, and the curved end face 33 has a radius of curvature of 1.64 mm. The in-plane lenses are closely spaced along each side of the display, with a gap of 0.05 mm between them.

It will be appreciated by those skilled in the art that the divergence angle 31 is determined by the wavelength of the sensing light and the parameters of the transmit waveguide 10, specifically its width and its active index contrast (i.e. the refractive index difference between the core material and cladding material). In this particular example the wavelength is 850 nm, the waveguides are each 10 μm wide and the refractive index contrast is 0.028, resulting in an experimentally measured divergence angle 31 of 11.3° It will also be appreciated that on the receive side, the acceptance angle of the receive waveguides attached to the in-plane lenses 17 is equal to the divergence angle 31, i.e. sensing light focussed by the curved end face of a receive lens will only be collected by the associated receive waveguide if it is within the acceptance angle of 11.3°. For maximum coverage of the display area, i.e. to minimise any ‘dark zones’ between sensing beams where a small touching object could be missed, the in-plane lenses 16 should be designed such that diffracting light 32 ‘fills’ the curved end face 33, as shown in FIG. 3a. Consequently, the divergence angle 31 imposes a constraint connecting the width 36 and length 35 of a lens 16: for light to ‘fill’ a 0.95 mm wide lens, the lens must be 4.8 mm long. This in turn limits the options for reducing bezel width via the lens design: if the lenses were simply made shorter, the sensing light would not ‘fill’ the lenses, leaving considerable ‘dark zones’ On the other hand, if the number of lenses (and associated waveguides) along each side were increased, then their width and length would be decreased (reducing the lens contribution to bezel width), but the waveguide array would be wider. By way of specific example, if the number of lenses were doubled (i.e. if there were 100 lenses along the shorter side and 132 along the longer side), each lens would be 0.475 mm wide and 2.4 mm long (i.e. 2.4 mm shorter than before), but the extra 116 waveguides would add 2.32 mm to the fairway width along the first side (for 10 μm wide waveguides with 10 μm gaps between them), largely negating any bezel width reduction.

As disclosed in US Patent Publication No 2006/0088244 A1, and as shown in FIG. 3b, one solution for decreasing the length 35 of each in-plane lens 16 is to incorporate a diverging lens 37 (comprising air for example) within the slab region 30 of the in-plane lens. To quote from US 2006/0088244 A1: ‘It will be appreciated that for a given “fill factor” of curved surface [37], the addition of a diverging lens reduces the length of the composite lens. For the particular application of waveguide-based optical touch screens, this length reduction advantageously reduces the width of the screen bezel within which the waveguides and lenses are located’ In a specific example, the incorporation of a diverging air lens 37 as described in Example 2 of US 2006/0088244 A1 will double the diffraction angle 31, thereby reducing the lens length 35 from 4.8 m to 2.4 mm, representing a substantial reduction in bezel width. This measure reduces the bezel width on both transmit sides of the display, and also on both receive sides because incorporation of a diverging air lens in a receive side in-plane lens 17 will likewise double the acceptance angle of the receive waveguides.

It will be appreciated that the 1×N splitter 18 and the transmit side in-plane lenses 16 both contain a slab region within which light entering one end of the slab is free to diverge in the in-plane dimension. Therefore the splitter 18 could be shortened in similar manner to in-plane lenses 16 and 17 by incorporating a diverging lens within its slab region to increase the divergence angle of light launched into it from the optical source 11. This measure does not reduce the width 26 of the first leg 23 of a transmit waveguide portion 20, but does reduce the overall area of the substrate 19.

Turning now to FIG. 3c, it should be noted that it is possible to reduce the width of the receive side substrate by reducing the length 38 of the slab region 39 of the receive side in-plane lenses 17. However if the slab region 39 is to have the same width as the corresponding slab region 30 of a transmit lens 16, it is difficult for all light in a received sensing beam 34 to be captured by the receive waveguide 14. As mentioned above, the acceptance angle of a receive waveguide 14 will be the same as the transmit-side divergence angle 31, 11.3° in the present example. Therefore if the entrance face 300 of the slab region 39 were redesigned to focus the received beam 34 more tightly (requiring a smaller radius of curvature), resulting in a convergence angle 301 greater than the acceptance angle of the receive waveguide 14, a portion of the light in the received beam 34 will be radiated into the cladding surrounding the receive waveguide 14, and into the supporting substrate. Alternatively, if the radius of curvature of the entrance face 300 were left unchanged, the light from the beam 34 would not be focussed down onto the entrance to the receive waveguide 14, again resulting in radiation loss into the surrounding cladding. This radiation loss, represented by rays 302, may remain guided in the cladding or substrate and could reach multi-element detector 15, degrading the signal-to-noise ratio. As discussed in PCT Publication No WO 07/048,180 (incorporated herein by reference), it is possible to tolerate such radiation loss if precautions are taken to strip the radiated light out of the cladding and substrate, for example by coating the substrate with a light absorbing layer.

We now turn to consideration of the gap 29 between the outer edge 201 of a substrate 19 and the outermost waveguide in the fairway 22. This gap is a consequence of the design of the 1×N tree splitter 18, where the slab region is generally wider than the array of output waveguides. Preferred designs of such splitters are discussed in US Patent Publication No 2006/0188198 A1, but in essence the excess width is necessary to ensure equal power distribution to the output waveguides. In one particular design of a 1×116 splitter, this excess width is approximately 0.8 mm on either side.

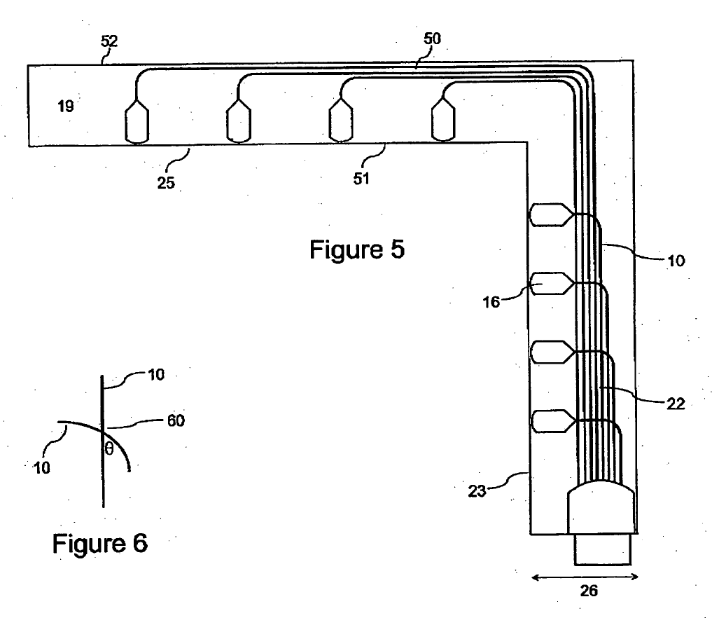

According to a first embodiment of the present invention, illustrated in FIG. 4, the gap 29 can be reduced by offsetting the 1×N tree splitter 18 with respect to the waveguide fairway 22, such that the edge 40 of the splitter's diffractive slab region coincides with the outermost waveguide of the fairway 22. The outer edge 201 of the substrate 19 can then be brought to within the dicing margin of the splitter edge 40 and the fairway 22. This offset is achieved by introducing an S-bend 41 into the waveguides after they emerge from the 1×N tree splitter, and reduces the width 26 of the (wider) first leg 23 of the substrate 19 by 0.8 mm. On the receive side, a similar S-bend could be used to eliminate any ‘dead zone’ between the edge of the multi-element detector and its array of detector pixels.

We now turn to consideration of the contribution to bezel width made by the waveguide bends 28. For right angle bends 28 as shown in FIG. 2, the contribution to bezel width is equal to the bend radius, and it will be appreciated that the bend-related contribution could be seduced (for any bend angle) by utilising tighter bends, i.e. decreasing the bend radius. However it will be appreciated by those skilled in the art that the optical loss incurred at a waveguide bend depends on the cross section of the waveguide and its core/cladding refractive index contrast, so there is a limit as to how tight a waveguide bend can be before unacceptably high bend loss occurs. For the specific case of 10 μm wide waveguides with a refractive index contrast of 0.028, a bend radius of 1.5 nm is acceptable in that the bend loss at a 90° bend will be less than 0.3 dB. It will be appreciated by those skilled in the art that the ‘acceptable’ bend radius will differ with the wavelength of the light being guided, and can be reduced (within material-imposed limits) by increasing the refractive index contrast. As disclosed in U.S. Pat. No. 7,218,812, incorporated herein by reference in its entirety, the refractive index contrast at a bend may be increased significantly by patterning the upper cladding such that the bend region (or at least the outside of the bend) is in contact with air (with a refractive index of approximately 1) instead of cladding material (which may for example comprise a polymer with a refractive index of approximately 1.48). However this complicates the fabrication process somewhat and may cause optical loss from scattering.

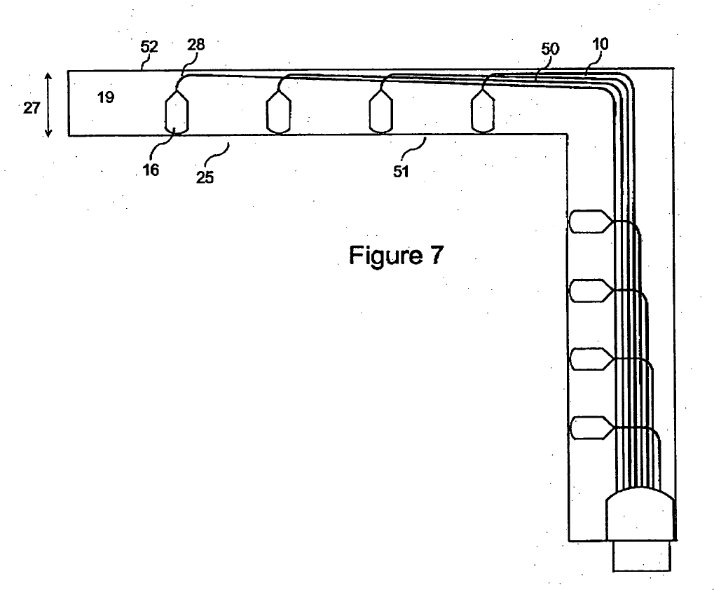

According to a second embodiment of the present invention, the bend-related contribution to bezel width can be reduced by changing the manner in which the waveguides 10 or 14 ‘peel off’ from their waveguide fairway towards their respective in-plane lenses 16 or 17. Instead of having each transmit waveguide 10 peeling off in turn from the inside of the fairway 22 as shown in FIG. 2, FIG. 5 shows a novel waveguide layout wherein, along at least a first side 23 of the L-shaped substrate 19, each transmit waveguide 10 peels off from the outside of the fairway, thereby crossing all of the remaining waveguides en route to its in-plane lens 16. The ‘inside’ of the waveguide fairway 22 is defined as the side closer to the in-plane lenses 16.

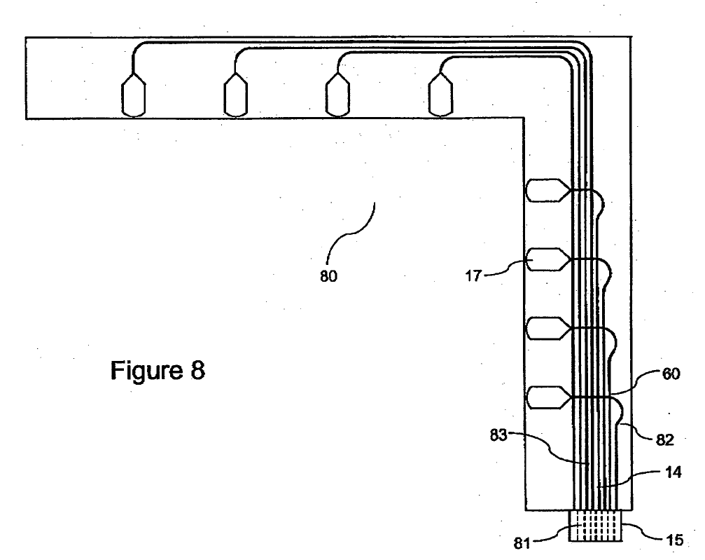

Unlike the case of an electronic circuit, where such crossings would be forbidden because of electrical shorting, optical waveguides can cross each other with impunity provided the crossing angle θ, as shown in FIG. 6, is sufficiently large. Providing the crossing angle is large enough, there will be minimal crosstalk (i.e. optical signals in each waveguide will not cross over to another waveguide) and minimal scattering loss at each crossing point 60. It will be appreciated from FIG. 5 that this ‘outside peel-off’ configuration reduces the width 26 of the first side 23 by an amount approximately equal to the bend radius, i.e. about 1.5 mm. A similar reduction would be obtained on the corresponding side of the receive-side L. Besides the potential problem of crosstalk, the crossing angle θ may also be constrained by the waveguide fabrication process. In particular; the ‘gap filling’ resolution limitation mentioned previously regarding photo-patternable polymers may limit how small θ can be made.

Close inspection of the FIG. 5 waveguide layout reveals that it is the presence of the ‘unused’ waveguides 10 along the first side 23 (i.e. those waveguides that lead to lenses 16 along the second side 25) that gives rise to the space saving benefit of the ‘outside peel-off’ arrangement. Consequently this arrangement, as shown in FIG. 5, offers minimal advantage along the second side 25 of the L-shaped transmit substrate 19 (i.e. it does not matter whether the waveguides 10 peel off from the inside or outside of the second waveguide fairway 50) in configurations where the waveguides in the second fairway 50 simply run substantially straight and parallel to the edges 51 and 52.

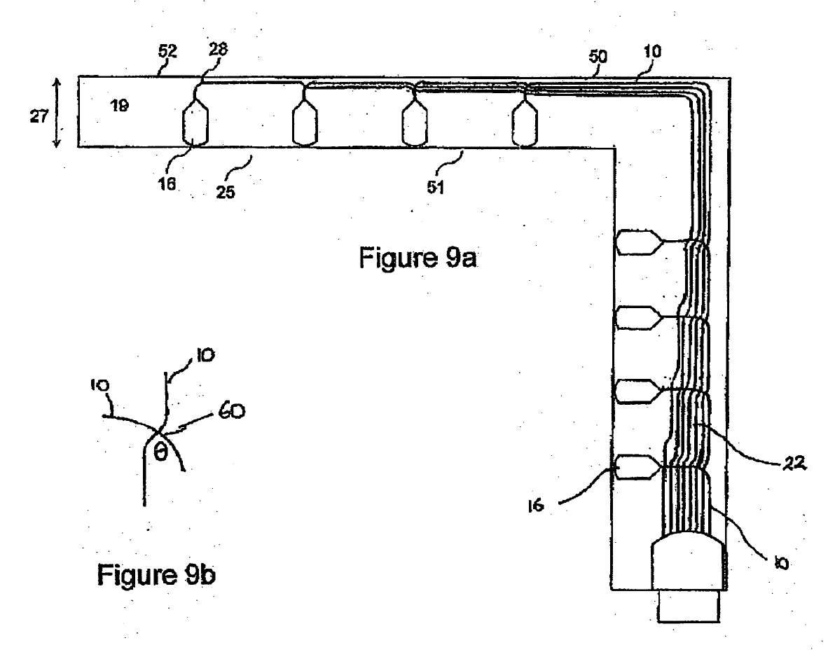

Nevertheless the ‘outside peel-off’ benefit can be made to apply along the second side 25 by other variations in the waveguide layout. For example FIG. 7 shows a waveguide layout according to a third embodiment of the present invention, in which the waveguides 10 in the second fairway 50 gradually bend away from the inner edge 51 towards the outer edge 52 before making the right angle bend 28 towards their respective in-plane lenses 16. With this configuration, the width 27 of the second side 25 is also reduced by an amount equal to the radius of the bends 28, i.e. 1.5 mm, and a similar width reduction would be obtained on the corresponding side of the receive substrate.

Returning to FIG. 6, we now consider what it means for the crossing angle θ to be ‘large enough’ for there to be negligible crosstalk and scattering loss at a crossing point 60. For crossings involving single-mode waveguides, it is generally accepted that a crossing angle of 20° or more is ‘large enough’, and even if the waveguides 10 are multi-molded (as they usually will be for the exemplary touch screen application), this is a useful benchmark. Inspection of the waveguide layout in FIG. 5 shows that as each waveguide 10 ‘peels off’ and crosses the remaining waveguides in the fairway 22, it is the first waveguide crossing that has the smallest crossing angle and is therefore the limiting factor. In the exemplary present layout, this smallest angle is approximately 10°, which may not be ‘large enough’ to prevent significant crosstalk and scattering loss. Note that on the transmit side, crosstalk is not a major problem because there is no positional information on that side; at worst, crosstalk would change the amount of optical power in each sensing beam. Therefore, depending on whether there is any significant scattering loss (which would adversely affect the power budget), crossing angles as small as 10° are deemed acceptable on the transmit side.

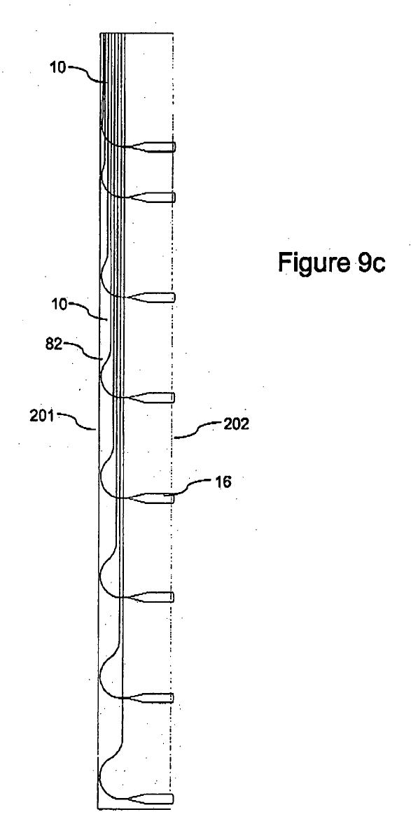

However for a receive side element 80 according to a fourth embodiment of the present invention as shown in FIG. 8, crosstalk should be minimised because the optical power in each receive waveguide 14 carries positional information. That is, for correct determination of a touch location, it is necessary for the signal light collected by each in-plane lens 17 to be faithfully guided to the respective detector elements 81 of the multi-element detector 15. Therefore on the receive side, it may be necessary to modify the outside peel-off waveguide layout arrangement with the addition of an extra bend 82 to each receive waveguide 14, to increase the crossing angle at each crossing point 60. In one embodiment the smallest crossing angle is increased from about 10° to about 40° by introducing an extra bend 82 that takes each receive waveguide 14 away from the fairway 83 by about 0.5 mm. Even so, the ‘outside peel-off’ configuration will still reduce the width 84 by 1.0 mm (compared to 1.5 mm without the extra bend 82). A less extensive extra bend 82 will be sufficient if crossing angles smaller than 40° are acceptable, and in general the optimal trade off between crossing angle and bezel width reduction will be also determined by several other design factors of a given touch system.

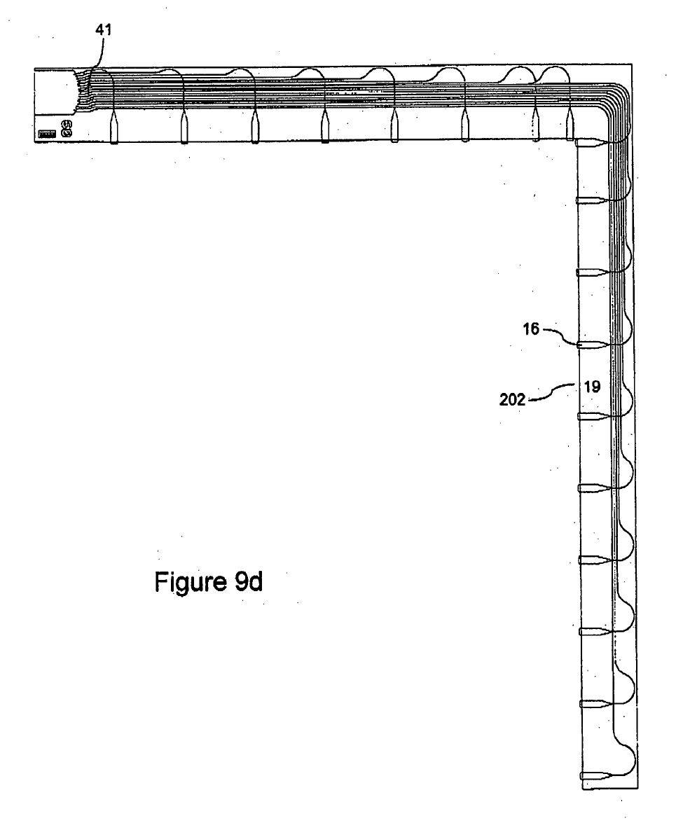

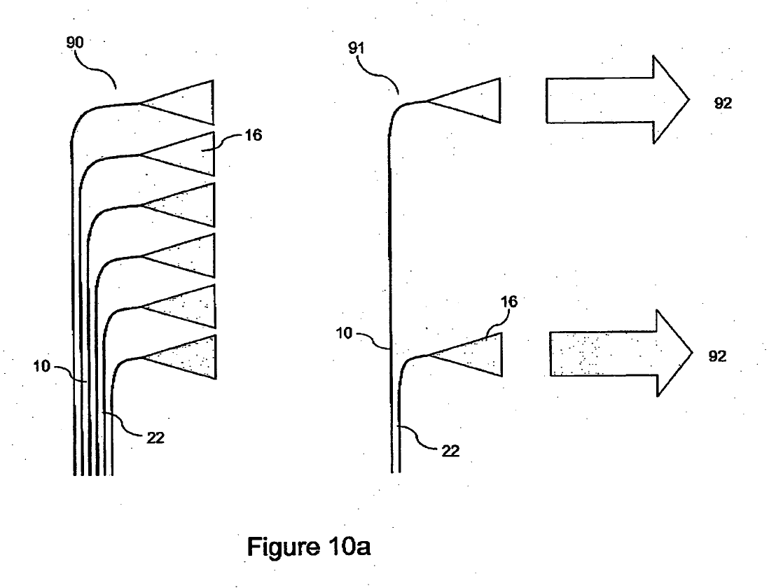

A fifth embodiment of the present invention comprising another variant waveguide crossing arrangement is shown in FIGS. 9a and 9b This embodiment is shown in respect of the transmit side but is equally applicable to the receive side as discussed above. Once again the waveguide fairway 22 exits the source 11 and splitter 18. The first or outermost waveguide 83 bends or ‘peels off’ from the waveguide fairway towards its respective in-plane lens 16 in a similar fashion to the embodiment shown in FIG. 5. In this embodiment however, the neighbouring waveguide 84 on the inside includes an S bend 85 similar to that shown in FIG. 4 (item 41) to move it outwardly to place it in the original path of the first waveguide 83 just after the bend 28 of the first waveguide, thereby increasing the crossing angle θ (compare FIGS. 6 and 9b). If necessary, other waveguides on the inside of the second waveguide 84 can similarly bend towards the outside edge of the waveguide fairway 22, to increase their crossing angle with the first waveguide 83

As we proceed downstream, once the second waveguide 84 reaches the appropriate position it ‘peels off’ from the waveguide fairway 22 towards the inner side and across the array to its respective in-plane lens 16 in much the same fashion as the first waveguide 83, and once again at least the neighbouring waveguide on the inside of the second waveguide moves outwardly towards the outside of the waveguide fairway 22 and the process repeats. It can be seen from FIG. 9a that this arrangement provides a similar reduction in bezel width 26 as that shown in FIG. 5, but it also advantageously increases the crossing angle, thereby reducing crosstalk between the crossing waveguides. As discussed above, a crossing angle of 20° or more is generally ‘large enough’ to reduce cross talk and scattering losses. It is envisaged, however, that crossing angles as small as 10° would be suitable on the transmit sides.

In much the same fashion as the embodiment shown in FIG. 7, the embodiment of FIG. 9a also has advantages on the second side of the L-shaped waveguide configuration; once again the width 27 on this side of the assembly can be substantially reduced if each sequential waveguide moves outwardly towards the outside edge of the fairway.

In a sixth embodiment of the present invention, FIG. 9c shows yet another layout involving waveguide crossings that reduces the width of a waveguide fairway. In this embodiment, an extra bend 82 (similar to that shown in FIG. 8) in each waveguide 10 towards the outside edge 201 of the substrate 19 before the waveguide turns towards its respective in-plane lens 16 enables the bend contribution to bezel width to be largely eliminated even in a unidirectional waveguide fairway 22. A similar configuration for a bidirectional waveguide fairway is shown in FIG. 9d; this figure also includes the S-bend 41 of the first embodiment of the present invention. Note that although FIGS. 9c and 9d appear to show the ends of the in-plane lenses 16 overhanging the inner edge 202 of the substrate 19, this is an artefact of the drawing package used to generate them; as explained previously, each lens 16 stops just short of the inner edge 202.

The final significant contribution to bezel width comes from the waveguide fairway, comprising an array of closely spaced parallel waveguides. For an optical touch system with 116 transmit waveguides and 116 receive waveguides, where the waveguides are 10 μm wide on a 20 μm pitch (i.e. separated by 10 μm gaps), the transmit fairway 22 and receive fairway 83 will each have a maximum width of 2.31 mm in the sections where all waveguides are present in the fairway, i.e. close to the splitter 18 and multi-element detector 15. This width could be reduced with narrower waveguides on a smaller pitch, but as mentioned previously, this may be constrained by the resolution of the waveguide fabrication process.

With purely planar waveguide layouts, although the width of the waveguide fairways can be decreased somewhat by reducing the width of each waveguide or their pitch, it can only be decreased significantly by reducing the number of waveguides. However this tends to reduce the spatial resolution of the touch screen sensor as a whole. As discussed above, the associated in-plane lenses should be closely spaced and ‘filled’ with light to minimise any ‘dark zones’ where a small touching object could be missed. In this configuration, spatial resolution (i.e. the accuracy with which a touching object can be located) depends on the size of the touching object relative to the lens width (which is approximately 1 mm in our specific example). Ideally the touching object should be wider than two receive lenses (approximately 2 mm), so it will always block all of one lens and parts of the two adjacent lenses. This enables grey-scaling, thereby achieving a spatial resolution of a quarter of the lens width (i.e. 0.25 mm), and possibly even better. Furthermore, if the touching object is moved, it can be tracked smoothly by the detection algorithms. On the other hand if the touching object is narrower than two receive lenses it cannot be guaranteed to block all of one lens, so the spatial resolution will be somewhat worse than 0.25 mm and there will be a degree of ‘hopping’ as the object is moved. If the touching object is narrower than one receive lens, the spatial resolution cannot be better than half the lens width, i.e. 0.5 mm.

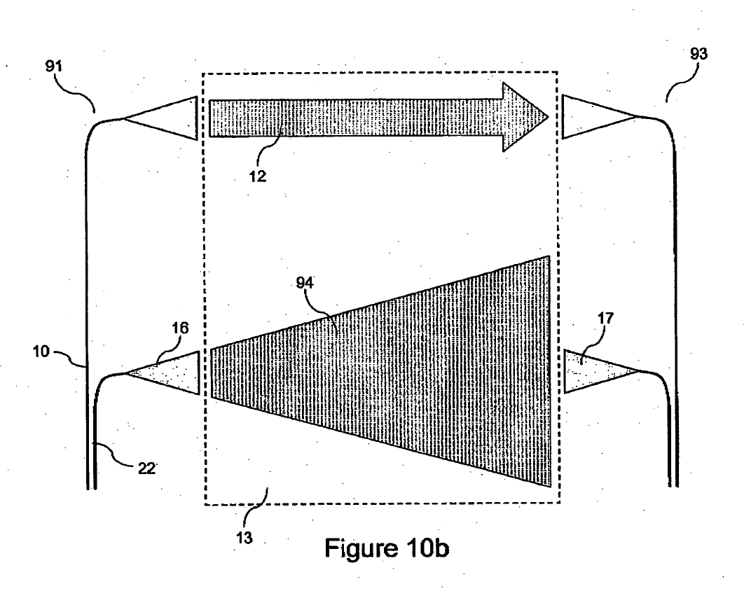

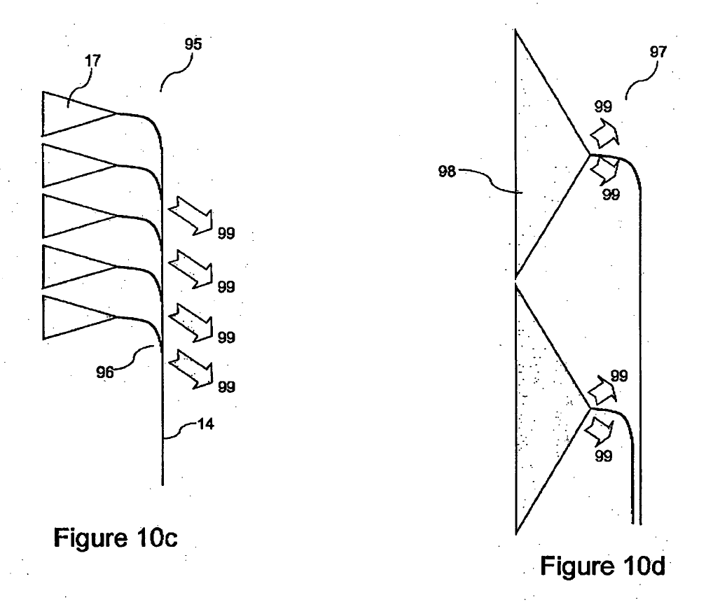

It can be seen then that the number of waveguides and lenses required depends on the desired spatial resolution and on the size of the touching object. For operation with a pen, where the tip may be of order 1 to 2 mm in size, a configuration with closely spaced 1 mm wide lenses may be required. However if a touch sensor only needs to operate with finger touch, the required spatial resolution is considerably less, so that the number of waveguides can be significantly reduced, thereby decreasing the width of the screen bezel. By way of illustration, we will describe various optical touch sensor configurations with one in-plane lens every 4 mm along the edges of the input area, instead of one every mm. On the transmit side, this change is relatively simple to implement: as shown in FIG. 10a, a ‘pen resolution’ transmit array 90 with closely spaced in-plane lenses 16 on a 1 mm pitch can be replaced with a ‘finger resolution’ transmit array 91 with 1 mm wide in-plane lenses 16 on a 4 mm pitch. Since an adult person's finger is of order 1 cm in size, at least one and probably two of the sensing beams 92 will still be blocked by a finger touch. The lenses 16 are the same size in each case, but the width of the transmit waveguide fairway 22 will be reduced by a factor of four in a ‘finger resolution’ transmit array 91. For example if a ‘pen resolution’ transmit array 90 has 116 waveguides 10 with a total width of 2.31 mm (as noted above), a ‘finger resolution’ transmit array 91 will only have 29 waveguides with a total width of 0.57 mm.

The situation on the receive side is not quite as straightforward. The analogous layout with a receive array 93 being the mirror image of a ‘finger resolution’ transmit array 91, shown in FIG. 10b, is certainly possible, and will yield a similar reduction in waveguide fairway width. However if the signal beams 12 are tightly collimated, this configuration causes a device assembly problem in that the transmit lenses 16 and receive lenses 17 need to be carefully aligned to face each other across the input area 13. This is not an impossible task, but does complicate the assembly process, thereby increasing costs. It is possible to avoid this alignment problem by simultaneously fabricating the transmit and receive waveguide arrays on a single substrate, but this is an inefficient use of substrate and waveguide materials. A preferable solution is to re-design the transmit lenses 16 so that they emit weakly collimated beams 94 that diverge as they traverse the input area 13 and will always illuminate a receive lens 17. This will of course reduce the optical efficiency of the system, but may be acceptable if the detector is sufficiently sensitive and the stray signal light from the beams 94 does not cause problems.

There are alternative ‘finger resolution’ receive array configurations that retain the waveguide fairway width saving while avoiding the alignment problem. One alternative ‘finger resolution’ receive array 95, shown in FIG. 10c, avoids the alignment problem by retaining a closely spaced array of receive lenses 17 and concatenating groups of M of their associated waveguides into a single receive waveguide 14, for example using cascaded 2:1 combiners 96 (as shown in FIG. 10c) or single M:1 combiners that are similar in film to the transmit side 1×N splitter 18. In another alternative receive array 97, shown in FIG. 10d, four 1 mm wide receive lenses could replaced by a single 4 mm wide receive lens 98. However all these alternatives incur radiation loss, represented for example by the arrows 99 at the 2:1 combiners 96 or at the ends of the wide receive lenses 98. As discussed above, the light lost to radiation modes may be trapped by the waveguide cladding or substrate, and will need to be stripped out or absorbed to prevent degradation of the signal-to-noise ratio at the detector 15. A further complication with the ‘wide lens’ configuration of FIG. 10d is that the signal beams would need to be weakly collimated (as in FIG. 10b) so as to illuminate a substantial portion of each lens, to ensure that at least some of the light is captured by the receive waveguide 14 (this follows from the limited capture angle of the receive waveguides, discussed above in FIGS. 3a, 3b and 3c).

Reducing the number of receive waveguides also has advantages at the detector: since fewer pixels need to be activated, the power consumption will be reduced and the processing speed increased.

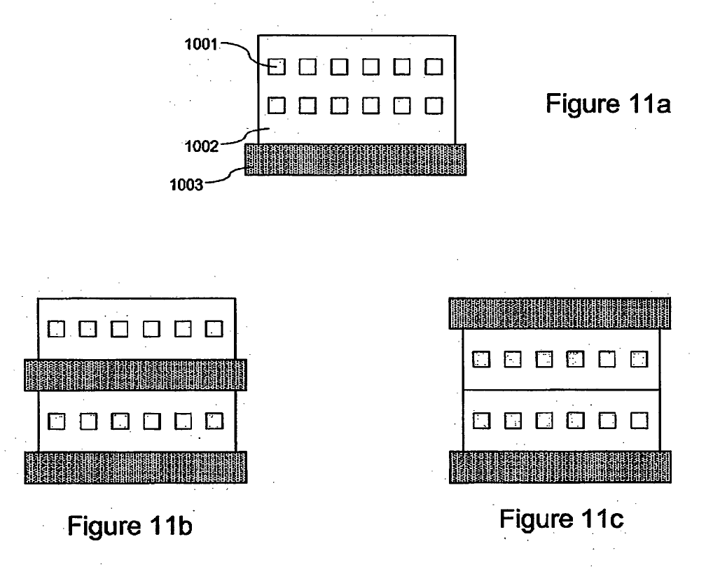

If ‘pen resolution’ is required, the waveguide fairway width can be reduced by adopting a multi-layer approach whereby on the transmit side, receive side or both, two of more arrays of waveguides are stacked vertically. For example on the transmit side, the waveguide arrays for launching the ‘X axis’ and ‘Y axis’ beams (each array including the 1×N splitter, waveguides and in-plane lenses) could be placed in separate layers, and likewise on the receive side. By way of example, this would reduce the width of a waveguide fairway from 2.31 mm (a single layer of 116 10 μm wide waveguides on a 20 μm pitch) to 1.31 mm (66 waveguides in one layer and 50 in another layer). Alternatively the waveguides could be split into two or more layers in any desired fashion. One method to stack the waveguides into two or more layers is to deposit and pattern multiple core 1001 and cladding 1002 layers onto a single substrate 1003, as shown in FIG. 11a. Another method is to fabricate the waveguides on multiple substrates 1003 and stack them during device assembly, as shown in FIGS. 11b and 11c for example. The first method is better for material usage and device assembly, but presents fabrication challenges such as planarisation, whereas the second method is straightforward from a fabrication perspective but complicates the assembly process. Irrespective of the method used to stack the waveguides, a multi-layer waveguide arrangement will be facilitated by using a large area optical source such as a light emitting diode (LED) and a two-dimensional detector array such as a digital camera chip; the use of such detectors in waveguide-based optical touch input devices has been disclosed in International PCT Application No PCT/AU2007/001400 entitled ‘Signal detection for optical touch input devices’, filed on 21 Sep. 2007 and incorporated herein by reference in its entirety. In particular, a single LED may be used to launch light into the 1×N splitters of two or more stacked transmit arrays, and two or more stacked receive arrays may be optically coupled to a single digital camera chip.

It should be noted that waveguide-based optical touch screen sensors with multiple layers of waveguides are known in the art, see for example FIG. 6c of U.S. Pat. No. 5,914,709. However in that disclosure the waveguides have been stacked in an interleaved fashion to enhance the spatial resolution, not to reduce the width of the waveguide fairway.

Having considered various space saving approaches for all four waveguide-related contributions to bezel width, we will now consider their total effect. Firstly we consider the case where ‘pen resolution’ is required and the waveguides are in a single layer: if all three of the other approaches (i.e. diverging air lens to reduce lens length, re-alignment of the 1×N splitter to eliminate the gap 29, and the ‘outside peel-off’ layout) are implemented, the width 26 of the first side 23 of an exemplary 116 waveguide transmit substrate 19 can be halved, from 9.5 mm to 4.8 mm (with savings of 2.4 mm, 0.8 mm and 1.5 mm from the respective approaches). On the other hand, if the waveguides awe additionally split into ‘X-axis and ‘Y-axis’ layers, the width 26 can be further reduced to 3.8 mm, for a total reduction of 60%.

These space saving approaches have been described in relation to a waveguide-based optical touch input device where the transmit and receive waveguides are located on L-shaped substrates positioned outside the perimeter of a display or input area 13, and where the optical source 11 and multi-element detector 15 are located at the ends of the shorter legs of their respective substrates (as shown in FIG. 1). However they are not so limited. For example they are also applicable to configurations where the optical source and multi-element detector are located elsewhere along their respective substrates, for example at the ends of the longer legs or at the corners of the L-shaped substrates. They are applicable to reducing the substrate width on the receive side in optical touch configurations, such as that disclosed in U.S. Pat. No. 7,099,553, that only have waveguide arrays on the receive side. They are also applicable to reducing the substrate width for the alternative optical touch configurations disclosed in International PCT Application No PCT/AU2007/001390 entitled ‘Waveguide configurations for optical touch systems’, filed on 20 Sep. 2007 and incorporated herein by reference in its entirety. In particular, in the assembly where the waveguide substrates are mounted perpendicular to the plane of the display, the width of the substrate translates to the depth of the device, and an excessively wide waveguide substrate may limit how thin an electronic device incorporating the touch input device can be made.

The space saving methods described in the present invention are furthermore not limited to optical touch input devices, and may be applicable to other integrated optical waveguide layouts, for example to reduce the space they occupy within a larger assembly or to reduce the costs associated with substrate or waveguide materials. Optical waveguide layouts involving waveguide crossings are known in optical switching matrices, where they may simply connect various switching elements (as disclosed for example in U.S. Pat. No. 5,892,864 and U.S. Pat. No. 6,385,362) or be active switching points (as disclosed for example in U.S. Pat. No. 4,753,505 and U.S. Pat. No. 6,327,397). However to our knowledge, waveguide layouts incorporating waveguide crossings purely as a space saving measure are not known in the art.

It would be understood by persons skilled in the art that variations and changes may be made to the embodiments of the invention discussed above without departing from the spirit or scope of the invention as defined by the claims.

1. A waveguide assembly for passing signals to or from an input area of an optical touch input device, said assembly comprising a plurality of waveguides extending between a respective plurality of lenses and a respective signal detector or signal source, wherein at least one waveguide crosses over at least one other waveguide in said assembly.

2. A waveguide assembly as claimed in claim 1 wherein said waveguides cross each other at an angle sufficiently large to minimise signal interference or cross talk between said waveguides.

3. A waveguide assembly as claimed in claim 2 wherein the size of said angle is a function of:
i) the materials comprising said waveguides; and/or
ii) the wavelength of an optical signal transmitted by said waveguides.

4. A waveguide assembly as claimed in claim 2 wherein said angle is greater than 10 degrees.

5. A waveguide assembly as claimed in claim 2 wherein said angle is greater than 40 degrees.

6. A waveguide assembly for passing signals to or from an input area of an optical touch input device, said assembly comprising a waveguide fairway defined by a plurality of waveguides that, at least along part of their length, extend in an array to thereby define inner and outer sides of said fairway, wherein waveguides on said outer side of said fairway cross over other waveguides in said allay to said inner side of said fairway for connection to lenses facing said input area of said touch input device.

7. A waveguide assembly for passing signals to or from an input area of an optical touch input device, said assembly comprising a waveguide fairway defined by a plurality of waveguides that, at least along part of their length, extend in an allay to thereby define inner and outer sides of said fairway, wherein each said waveguide at some point along its length is directed toward said outer side of said fairway.

8. A waveguide assembly as claimed in claim 6 wherein said waveguides are directed towards said outer side of said fairway at substantially the same point along their length.

9. A waveguide assembly as claimed in claim 6 wherein said waveguides are directed towards said outer side of said fairway sequentially at different points along their length.

10. A waveguide assembly as claimed in claim 7 wherein said assembly is produced on an L-shaped substrate, said waveguides being formed on two portions of said substrate substantially at right angles to each other, each portion having an array of waveguides for waveguide assembly connection to said respective plurality of lenses.

11. A waveguide assembly according to claim 7 comprising a plurality of waveguide assemblies stacked on top of each other to define a multi-layer waveguide assembly.

12. A waveguide assembly as claimed in claim 7 wherein said plurality of waveguides extend along at least part of their length in a mutually parallel spaced apart array.

13. A method for reducing bezel width in an optical touch input device; said method comprising the steps of providing a waveguide assembly for passing signals to or from an input area of said optical touch input device, said assembly comprising a plurality of waveguides extending between a respective plurality of lenses and a respective signal detector or signal source, wherein at least one waveguide crosses over at least one other waveguide in said assembly.

14. A method for reducing bezel width in an optical touch input device; said method comprising the steps of providing a waveguide assembly for passing signals to or from an input area of said optical touch input device, said assembly comprising a waveguide fairway defined by a plurality of waveguides that, at least along part of their length, extend in an array to thereby define inner and outer sides of said fairway, wherein waveguides on said outer side of said fairway cross over other waveguides in said array to said inner side of said fairway for connection to lenses facing said input area of said touch input device.

15. A method for reducing bezel width in an optical touch input device; said method comprising the steps of providing a waveguide assembly for passing signals to or from an input area of said optical touch input device, said assembly comprising a waveguide fairway defined by a plurality of waveguides that, at least along part of their length, extend in an array to thereby define inner and outer sides of said fairway, wherein each said waveguide at some point along its length is directed toward said outer side of said fairway.

16. A method according to claim 14 wherein said waveguides are directed towards said outer side of said fairway at substantially the same point along their length.

17. A method according to claim 14 wherein said waveguides are directed towards said outer side of said fairway sequentially at different points along their length.

18. A method according to claim 13 wherein said assembly is produced on an L-shaped substrate, said waveguides being formed on two portions of said substrate substantially at tight angles to each other; each portion having an array of waveguides for waveguide assembly connection to said respective plurality of lenses.

19. A method according to claim 13 wherein said waveguides cross each other at an angle sufficiently large to minimise signal interference or cross talk between said waveguides.

20. A method according to claim 19 wherein the size of said angle is a function of: i) the materials comprising said waveguides; and/or ii) the wavelength of an optical signal transmitted by said waveguides.

21. A method according to claim 19 wherein said angle is greater than 10 degrees.

22. A method according to claim 19 wherein said angle is greater than 40 degrees.

23. A method according to claim 19 comprising a plurality of waveguide assemblies stacked on top of each other to define a multi-layer waveguide assembly.

24. A method according to claim 12 wherein a waveguide assembly as claimed in anyone of the preceding claims wherein said plurality of waveguides extend along at least part of their length in a mutually parallel spaced apart array.
